(19) United States
(12) Patent Application Publication
(10) Pub. No.: US 2020/0355342 A1
(43) Pub. Date: Nov. 12, 2020

(54) Vehicle Luminaire and Vehicle Lamp

(71) Applicant: Toshiba Lighting & Technology Corporation, Yokosuka-shi (JP)

(72) Inventors: Toshihiro Hatanaka, Yokosuka-shi (JP); Ryuji Tsuchiya, Yokosuka-shi (JP); Kiyokazu Hino, Yokosuka-shi (JP)

(73) Assignee: Toshiba Lighting & Technology Corporation, Yokosuka-shi (JP)

(21) Appl. No.: 16/800,440

(22) Filed: Feb. 25, 2020

(30) Foreign Application Priority Data
May 10, 2019 (JP) 2019-089676

(51) Int. Cl. F21S 45/48; F21S 41/14; F21S 43/13; F21V 29/76

(52) U.S. Cl. CPC F21S 45/48; F21S 41/14; F21Y 2115/00; F21V 29/76; F21S 43/13

(57) ABSTRACT

A vehicle luminaire according to an embodiment includes: a socket which includes a concave portion and a convex portion provided in a bottom surface of the concave portion; and a light-emitting module which is provided inside the concave portion. The convex portion includes a seat portion and at least one connection portion of which one end portion is connected to a side wall of the seat portion and the other end portion is connected to a side wall of the concave portion. The light-emitting module includes a substrate which is provided in a surface opposite to the bottom surface of the concave portion in the seat portion with a heat transfer portion interposed therebetween and at least one light-emitting element which is provided in the substrate. A planar dimension of the seat portion is smaller than a planar dimension of the substrate.

### CROSS-REFERENCE TO RELATED APPLICATIONS

This application is based upon and claims the benefit of priority from Japanese Patent Application No. 2019-089676, filed on May 10, 2019; the entire contents of which are incorporated herein by reference.

### FIELD

Embodiments described herein relate generally to a vehicle luminaire and a vehicle lamp.

### BACKGROUND

A vehicle luminaire including a socket and a light-emitting module provided in one end portion side of the socket is known. The light-emitting module is provided with a substrate and one surface of the substrate is provided with a light-emitting element, a resistor and other components.

Here, when a voltage is applied to the light-emitting module, heat is generated in the light-emitting element, the resistor or the like. The generated heat is mainly transferred to the socket through the substrate and is discharged from the socket to the outside. In this case, when the heat is not easily transferred to the socket, the temperature of the light-emitting element increases too much. Accordingly, there is concern that the light-emitting element may be broken or the function of the light-emitting element may deteriorate.

For that reason, the substrate of the light-emitting module is attached to the socket by using an adhesive or grease with high thermal conductivity. Incidentally, there is a case in which an adhesive or grease with high heat conductivity may have conductivity. For that reason, when the substrate is pressed against the adhesive or grease applied to the socket, there is concern that the adhesive or grease having conductivity may rise on the surface of the substrate on which the light-emitting element or the like is provided and short-circuiting, dirt or the like may occur.

Here, it is desired to develop a technique capable of efficiently transferring heat generated in a light-emitting module to a socket and suppressing a rise of an adhesive, grease or the like.

### DESCRIPTION OF THE DRAWINGS

FIG. 1 is a schematic perspective view illustrating a vehicle luminaire according to an embodiment.

FIG. 2 is a cross-sectional view taken along a line A-A of the vehicle luminaire.

FIG. 3A is a schematic front view illustrating a convex portion and FIG. 3B is a cross-sectional view taken along a line B-B of a socket of FIG. 3A.

FIG. 4A is a schematic front view illustrating a seat portion according to a comparative example and FIG. 4B is a cross-sectional view taken along a line C-C of a socket of FIG. 4A.

FIG. 5 is a schematic front view illustrating the number and arrangement of connection portions.

FIG. 6 is a schematic front view illustrating the number and arrangement of connection portions.

FIG. 7 is a partially cross-sectional view schematically illustrating a vehicle lamp.

### DETAILED DESCRIPTION

A vehicle luminaire according to an embodiment includes: a socket which includes a concave portion opening to one end portion and a convex portion provided in a bottom surface of the concave portion; and a light-emitting module which is provided inside the concave portion. The convex portion includes a seat portion which protrudes from the bottom surface of the concave portion and at least one connection portion of which one end portion is connected to a side wall of the seat portion and the other end portion is connected to a side wall of the concave portion. The light-emitting module includes a substrate which is provided in a surface opposite to the bottom surface of the concave portion in the seat portion with a heat transfer portion interposed therebetween and at least one light-emitting element which is provided in the substrate. A planar dimension of the seat portion is smaller than a planar dimension of the substrate.

Hereinafter, embodiments will be illustrated with reference to the drawings. Additionally, in the drawings, the same elements will be denoted by the same reference numerals and a detailed description thereof will be appropriately omitted.

(Vehicle Luminaire)

A vehicle luminaire 1 according to the embodiment can be provided in, for example, automobiles and railway cars. As the vehicle luminaire 1 provided in automobiles, for example, one used in a front combination light (for example, an appropriate combination of a daytime running lamp (DRL), a position lamp, a turn signal lamp, and the like) or a rear combination light (for example, an appropriate combination of a stop lamp, a tail lamp, a turn signal lamp, a back lamp, a fog lamp, and the like) can be illustrated. However, the application of the vehicle luminaire 1 is not limited to these.

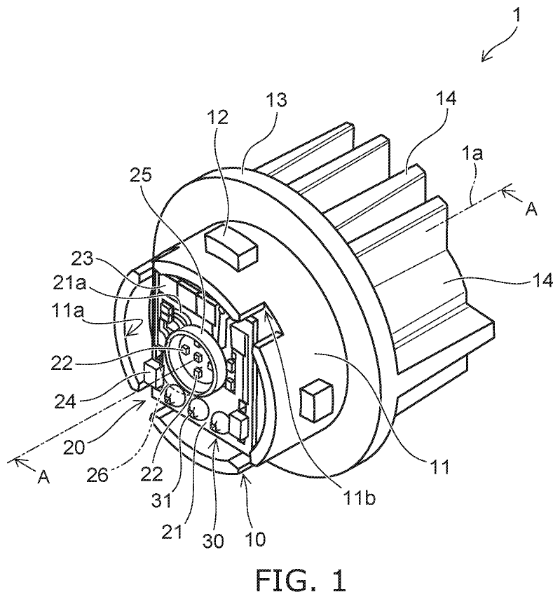

FIG. 1 is a schematic perspective view illustrating the vehicle luminaire 1 according to the embodiment.

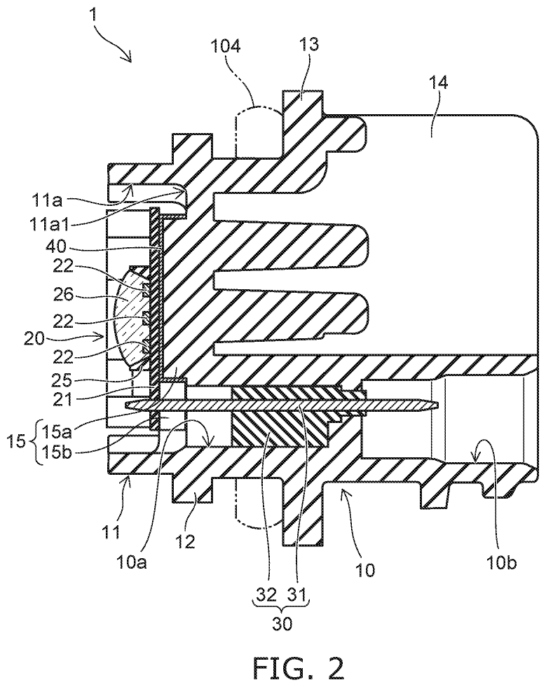

FIG. 2 is a cross-sectional view taken along a line A-A of the vehicle luminaire 1 of FIG. 1.

As illustrated in FIGS. 1 and 2, the vehicle luminaire 1 can be provided with a socket 10, a light-emitting module 20, a power-supply portion 30, and a heat transfer portion 40.

The socket 10 can include an attachment portion 11, a bayonet 12, a flange 13, a thermal radiation fin 14, and a convex portion 15.

The attachment portion 11 can be provided in a surface opposite to a side provided with the thermal radiation fin 14 in the flange 13. The external shape of the attachment portion 11 can be a pillar shape. The external shape of the attachment portion 11 is, for example, a columnar shape. The attachment portion 11 can include a concave portion 11a which opens to an end portion opposite to the flange 13.

The attachment portion 11 can be provided with at least one slit 11b. A corner portion of a substrate 21 can be provided inside the slit 11b. The dimension (width) of the slit 11b in the circumferential direction of the attachment portion 11 can be slightly larger than the dimension of the corner portion of the substrate 21. In this way, the substrate 21 can be positioned by inserting the corner portion of the substrate 21 into the slit 11b.

Further, when the slit 11b is provided, the planar shape of the substrate 21 can be enlarged. For that reason, it is possible to increase the number of elements mounted on the substrate 21. Alternatively, since the external shape dimension of the attachment portion 11 can be decreased, it is possible to decrease the size of the attachment portion 11 and to further decrease the size of the vehicle luminaire 1.

The bayonet 12 can be provided in the outer surface of the attachment portion 11. For example, the bayonet 12 protrudes toward the outside of the vehicle luminaire 1. The bayonet 12 can face the flange 13. A plurality of the bayonets 12 can be provided. The bayonet 12 can be used at the time of attaching the vehicle luminaire 1 to a casing 101 of a vehicle lamp 100. The bayonet 12 can be used for twist lock.

The flange 13 can have a plate shape. For example, the flange 13 can have a disk shape. The outer surface of the flange 13 can be located at the outside of the vehicle luminaire 1 in relation to the outer surface of the bayonet 12.

The thermal radiation fin 14 can be provided on the side opposite to the attachment portion 11 in the flange 13. At least one thermal radiation fin 14 can be provided. For example, the socket 10 illustrated in FIGS. 1 and 2 is provided with the plurality of thermal radiation fins 14. The plurality of thermal radiation fins 14 can be arranged side by side in a predetermined direction. The thermal radiation fin 14 can have a plate shape.

The convex portion 15 can be provided in a bottom surface 11a1 of the concave portion 11a. The convex portion 15 can be provided with the light-emitting module 20 with the heat transfer portion 40 interposed therebetween. Additionally, the convex portion 15 will be described in detail later.

Further, the socket 10 can be provided with a hole 10b into which a connector 105 is inserted. The connector 105 with a seal member 105a can be inserted into the hole 10b. For that reason, the cross-sectional shape of the hole 10b can be suitable for the cross-sectional shape of the connector 105 with the seal member 105a.

The socket 10 can have a function of holding the light-emitting module 20 and the power-supply portion 30 and a function of transferring heat generated in the light-emitting module 20 to the outside. For that reason, the socket 10 is desirably formed of a material having high heat conductivity. For example, the socket 10 can be formed of metal such as aluminum alloy.

Further, in recent years, it is desirable that the socket 10 can efficiently radiate heat generated in the light-emitting module 20 and be light. For that reason, the socket 10 is desirably formed using a high thermal conductive resin. The high thermal conductive resin includes, for example, a filler formed of a resin or an inorganic material. The high thermal conductive resin can be, for example, a resin obtained by mixing a filler such as carbon or aluminum oxide with a resin such as Polyethylene terephthalate (PET) or nylon.

Further, a part of the elements constituting the socket 10 can be formed using metal and the remaining elements can be formed using a high thermal conductive resin.

However, in the socket 10 in which the attachment portion 11, the bayonet 12, the flange 13, the thermal radiation fin 14, and the convex portion 15 (a seat portion 15a and a connection portion 15b) are integrally molded with one another by including a high thermal conductive resin, heat generated in the light-emitting module 20 can be effectively radiated. Further, the weight of the socket 10 can be light.

In this case, the attachment portion 11, the bayonet 12, the flange 13, the thermal radiation fin 14, and the convex portion 15 can be integrally molded using an injection-molding method or the like. Further, the socket 10 and the power-supply portion 30 can be integrally molded using an insert-molding method or the like.

The light-emitting module 20 can be provided inside the concave portion 11a.

The light-emitting module 20 can include the substrate 21, a light-emitting element 22, a resistor 23, and a control element 24.

The substrate 21 can be provided in a surface opposite to the bottom surface 11a1 of the concave portion 11a in the seat portion 15a with the heat transfer portion 40 interposed therebetween. The substrate 21 can have a plate shape. The planar shape of the substrate 21 can be, for example, a square. The substrate 21 can be formed of, for example, an inorganic material such as ceramics (for example, aluminum oxide or aluminum nitride) or an organic material such as paper phenol or glass epoxy. Further, the substrate 21 may be a metal plate whose surface is covered with an insulating material. When the surface of the metal plate is covered with an insulating material, the insulating material may be formed of an organic material or may be formed of an inorganic material. When the light-emitting element 22 generates a large amount of heat, it is desirable to form the substrate 21 using a material having high heat conductivity from the viewpoint of heat radiation. As the material having high heat conductivity, for example, ceramics such as aluminum oxide and aluminum nitride, a high thermal conductive resin, and a metal plate whose surface is covered with an insulating material can be exemplified. Further, the substrate 21 may have a single layer structure or a multi-layer structure.

Further, a wiring 21a can be provided in a surface of the substrate 21. The wiring 21a can be formed of, for example, a material including silver as a main component or can be formed of a material including copper as a main component.

The light-emitting element 22 can be provided on the side opposite to the bottom surface 11a1 of the concave portion 11a in the substrate 21. The light-emitting element 22 can be electrically connected to the wiring 21a. At least one light-emitting element 22 can be provided. In the case of the vehicle luminaire 1 illustrated in FIGS. 1 and 2, the plurality of light-emitting elements 22 are provided. Additionally, when the plurality of light-emitting elements 22 are provided, the plurality of light-emitting elements 22 can be connected in series to each other. Further, the light-emitting element 22 can be connected in series to the resistor 23.

The light-emitting element 22 can be, for example, a light-emitting diode, an organic light-emitting diode, a laser diode, or the like.

The light-emitting element 22 may be a chip-shaped light-emitting element, a surface mounted light-emitting element, or a shell type light-emitting element having a lead wire. However, the chip-shaped light-emitting element is desirable in consideration of a decrease in size of the substrate 21 and further a decrease in size of the vehicle luminaire 1.

The chip-shaped light-emitting element 22 can be mounted on the wiring 21a by a Chip On Board (COB). When the light-emitting element 22 is a light-emitting element of an upper and lower electrode type or a light-emitting element of an upper electrode type, the light-emitting element 22 can be electrically connected to the wiring 21a by, for example, a wire bonding method. When the light-emitting element 22 is a flip chip type light-emitting element, the light-emitting element 22 can be directly connected to the wiring 21a.

The light emission surface of the light-emitting element 22 faces the front side of the vehicle luminaire 1. The light-emitting element 22 mainly emits light toward the front side of the vehicle luminaire 1. The number, size, arrangement, and the like of the light-emitting elements 22 are not limited to those illustrated and can be appropriately changed in response to the size, application, or the like of the vehicle luminaire 1.

The resistor 23 can be provided on the side opposite to the bottom surface 11a1 of the concave portion 11a in the substrate 21. The resistor 23 can be electrically connected to the wiring 21a. The resistor 23 can be, for example, a surface mounted resistor, a resistor (metal oxide film resistor) having a lead wire, a film-shaped resistor formed using a screen printing method, or the like. Additionally, the resistor 23 illustrated in FIG. 1 is a film-shaped resistor.

As a material of the film-shaped resistor, for example, ruthenium oxide (RuO₂) can be used. The film-shaped resistor can be formed using, for example, a screen printing method and a baking method. If the resistor 23 is the film-shaped resistor, the contact area between the resistor 23 and the substrate 21 can be large and hence thermal radiation performance can be improved. Further, the plurality of resistors 23 can be formed at one time. For that reason, productivity can be improved. Further, it is possible to suppress a variation in the resistance value of the plurality of resistors 23.

Here, since there is a variation in the forward voltage characteristic of the light-emitting element 22, the brightness (light flux, luminance, luminous intensity, illuminance) of the light emitted from the light-emitting element 22 varies when the voltage applied between the anode terminal and the ground terminal is kept constant. For that reason, the value of the current flowing to the light-emitting element 22 can be set within a predetermined range by the resistor 23 so that the brightness of the light emitted from the light-emitting element 22 falls into a predetermined range. In this case, the value of the current flowing to the light-emitting element 22 can be set within a predetermined range by changing the resistance value of the resistor 23.

When the resistor 23 is a surface mounted resistor or a resistor with a lead wire, the resistor 23 having an appropriate resistance value in response to the forward voltage characteristics of the light-emitting element 22 can be selected. When the resistor 23 is a film-shaped resistor, the resistance value can be increased if a part of the resistor 23 is removed. The number, size, arrangement, and the like of the resistors 23 are not limited to those illustrated and can be appropriately changed in response to the number, specifications, and the like of the light-emitting elements 22.

The control element 24 can be provided on the side opposite to the bottom surface 11a1 of the concave portion 11a in the substrate 21. The control element 24 can be electrically connected to the wiring 21a. The control element 24 can be provided so that a reverse voltage is not applied to the light-emitting element 22 and a pulse noise is not applied to the light-emitting element 22 from a reverse direction. The control element 24 can be, for example, a diode. The control element 24 can be, for example, a surface mounted diode or a diode including a lead wire. The control element 24 illustrated in FIG. 1 is a surface mounted diode. In addition, a pull-down resistor can also be provided in order to detect disconnection of the light-emitting element 22 and prevent erroneous lighting. Further, a covering portion that covers the wiring 21a or the film-shaped resistor can be provided. The covering portion can include, for example, a glass material.

When the light-emitting element 22 is the chip-shaped light-emitting element, the light-emitting module 20 can further include a frame 25 and a sealing portion 26.

The frame 25 can be provided on the side opposite to the bottom surface 11a1 of the concave portion 11a in the substrate 21. The frame 25 can be bonded onto the substrate 21. The frame 25 can have a frame shape. At least one light-emitting element 22 can be provided in a region surrounded by the frame 25. For example, the frame 25 can surround the plurality of light-emitting elements 22. The frame 25 can be formed of a resin. The resin can be, for example, a thermoplastic resin such as polybutylene terephthalate (PBT), polycarbonate (PC), PET, nylon, polypropylene (PP), polyethylene (PE), and polystyrene (PS).

Further, it is possible to improve the reflectance of the light emitted from the light-emitting element 22 by mixing particles of titanium oxide or the like in the resin. Additionally, the embodiment is not limited to the particles of titanium oxide and particles of a material having high reflectance with respect to the light emitted from the light-emitting element 22 may be mixed. Further, the frame 25 can be formed of, for example, a white resin. That is, the frame 25 can have a function of defining the formation range of the sealing portion 26 and a function of the reflector.

Additionally, a case in which the frame 25 is molded using an injection-molding method or the like and the molded frame 25 is bonded to the substrate 21 is illustrated, but the embodiment is not limited thereto. For example, the frame 25 can also be formed by applying a dissolved resin in a frame shape on the substrate 21 using a dispenser or the like and curing the resin.

Further, the frame 25 can be omitted. When the frame 25 is omitted, the dome-shaped sealing portion 26 covering the light-emitting element 22 can be provided. Additionally, when the frame 25 is provided, the formation range of the sealing portion 26 can be defined. For that reason, since it is possible to suppress an increase in the planar dimension of the sealing portion 26, it is possible to decrease the size of the substrate 21 and further decrease the size of the vehicle luminaire 1.

The sealing portion 26 can be provided in a region surrounded by the frame 25. The sealing portion 26 can be provided so as to cover the region surrounded by the frame 25. The sealing portion 26 can be provided so as to cover the light-emitting element 22. The sealing portion 26 can be formed of a material having translucency. For example, the sealing portion 26 can be formed by filling a resin into the region surrounded by the frame 25. The filling of the resin can be performed by, for example, liquid dispensing equipment such as a dispenser. The resin to be filled can be, for example, a silicone resin. Further, the sealing portion 26 can include a phosphor. The phosphor can be, for example, a YAG phosphor (yttrium.aluminum.garnet phosphor). However, the type of the phosphor can be appropriately changed so that a predetermined emission color can be obtained according to the application of the vehicle luminaire 1 or the like. Additionally, when the light-emitting element 22 is a surface mounted light-emitting element or a shell type light-emitting element having a lead wire, the frame 25 and the sealing portion 26 can be omitted. However, as described above, the light-emitting element 22 is desirably the chip-shaped light-emitting element and the frame 25 and the sealing portion 26 are desirably provided in consideration of a decrease in size of the substrate 21.

The power-supply portion 30 can include a power-supply terminal 31 and a holding portion 32.

The power-supply terminal 31 can be a bar-shaped member. The power-supply terminal 31 can protrude from the bottom surface 11a1 of the concave portion 11a. A plurality of the power-supply terminals 31 can be provided. The plurality of power-supply terminals 31 can be arranged in a predetermined direction. The plurality of power-supply terminals 31 extend inside the holding portion 32. The end portions on the side of the light-emitting module 20 in the plurality of power-supply terminals 31 can be soldered to the wiring 21a provided on the substrate 21. The end portions on the side of the thermal radiation fin 14 in the plurality of power-supply terminals 31 can be exposed into the hole 10b.

The connector 105 can be fitted to the plurality of power-supply terminals 31 exposed into the hole 10b. The power-supply terminal 31 can be formed of, for example, metal such as copper alloy. Additionally, the number, shape, arrangement, material, and the like of the power-supply terminals 31 are not limited to those illustrated, but can be appropriately changed.

As described above, the socket 10 is desirably formed of a material having high heat conductivity. Incidentally, there is a case in which the material having high heat conductivity has conductivity. For example, metals such as aluminum alloys and high thermal conductive resins including carbon fillers have conductivity. For that reason, the holding portion 32 can be provided in order to insulate between the power-supply terminal 31 and the conductive socket 10. Further, the holding portion 32 can also have a function of holding the plurality of power-supply terminals 31. Additionally, when the socket 10 is formed of a high thermal conductive resin having an insulating property (for example, a high thermal conductive resin including a filler formed of aluminum oxide), the holding portion 32 can be omitted. In this case, the socket 10 can hold the plurality of power-supply terminals 31.

The holding portion 32 can be formed of a resin having an insulation property. The holding portion 32 can be pressed into, for example, a hole 10a provided in the socket 10 or bonded to an inner surface of the hole 10a.

The heat transfer portion 40 can be provided between the substrate 21 and the convex portion 15. A part of the heat transfer portion 40 can be provided in at least a part of the side wall of the seat portion 15a. The heat transfer portion 40 can be formed, for example, by curing an adhesive having high heat conductivity. The adhesive having high heat conductivity can be, for example, an adhesive in which a filler using an inorganic material is mixed. The heat conductivity of the adhesive can be, for example, 0.5 W/(m.K) or more and 10 W/(m·K) or less.

Further, the heat transfer portion 40 can be formed by a layer formed of thermal conductive grease (thermal radiation grease). The thermal conductive grease can be, for example, a mixture of modified silicone and a filler using an inorganic material. The heat conductivity of the thermal conductive grease can be, for example, 1 W/(m·K) or more and 5 W/(m·K) or less. In addition, when the heat transfer portion 40 is formed by a layer formed of thermal conductive grease, a holding portion holding the substrate 21 can be provided inside the concave portion 11a.

When the heat transfer portion 40 is provided, heat generated in the light-emitting module 20 is easily transferred to the socket 10. Here, there is a case in which an adhesive or grease rises on a surface provided with the light-emitting element 22 and the like in the substrate 21 when the substrate 21 is pressed against the adhesive, grease or the like applied to the seat portion 15a. Since the adhesive, grease or the like having high heat conductivity is often electrically conductive, there is concern that disconnection occurs when the adhesive, grease or the like rises on the surface of the substrate 21.

Further, when the adhesive, grease or the like having high heat conductivity rises on the substrate 21, there is concern that the appearance may be impaired and the commercial value may be decreased. Here, the socket 10 is provided with the convex portion 15.

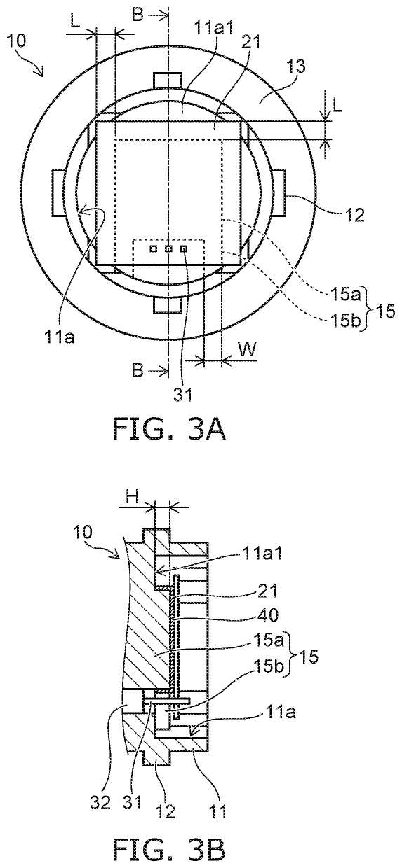

FIG. 3A is a schematic front view illustrating the convex portion 15.

Additionally, in FIG. 3A, elements provided on the substrate 21 are omitted to avoid complexity.

FIG. 3B is a cross-sectional view taken along a line B-B of the socket 10 in FIG. 3A.

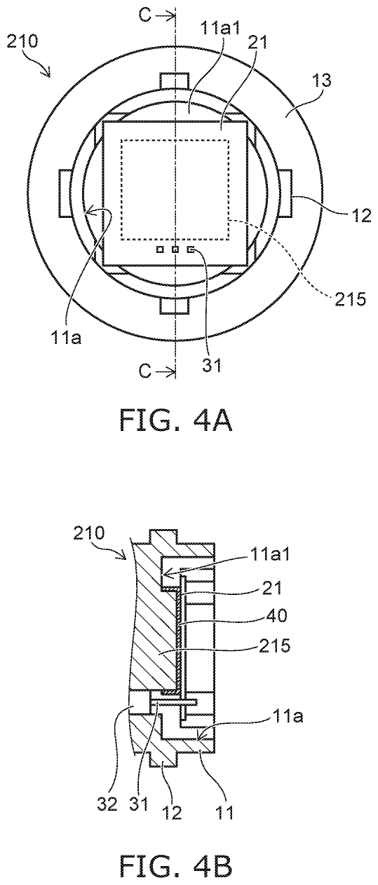

FIG. 4A is a schematic front view illustrating a seat portion 215 according to a comparative example.

Additionally, in FIG. 4A, elements provided on the substrate 21 are omitted to avoid complexity.

FIG. 4B is a cross-sectional view taken along a line C-C of the socket 210 of FIG. 4A.

As illustrated in FIGS. 3A and 3B, the convex portion 15 can include the seat portion 15a and the connection portion 15b. The seat portion 15a can protrude from the bottom surface 11a1 of the concave portion 11a. A surface opposite to the bottom surface 11a1 in the seat portion 15a can be a flat surface. The substrate 21 can be provided on the surface opposite to the bottom surface 11a1 in the seat portion 15a with the heat transfer portion 40 interposed therebetween.

As illustrated in FIG. 3A, the planar dimension of the seat portion 15a can be set to be smaller than the planar dimension of the substrate 21. In plan view, the vicinity of the peripheral edge of the substrate 21 can be located at the outside in relation to the peripheral edge of the seat portion 15a. In this way, a space can be provided between the vicinity of the peripheral edge of the substrate 21 and the bottom surface 11a1 of the concave portion 11a. If the space is provided between the vicinity of the peripheral edge of the substrate 21 and the bottom surface 11a1 of the concave portion 11a, the remaining adhesive, grease or the like can be received in the space when the substrate 21 is pressed against the applied adhesive, grease or the like. For that reason, it is possible to suppress an adhesive, grease or the like from rising on a surface provided with the light-emitting element 22 and the like in the substrate 21.

As illustrated in FIGS. 4A and 4B, the seat portion 215 according to the comparative example protrudes from the bottom surface 11a1 of the concave portion 11a. In this case, the connection portion 15b is not provided and only the seat portion 215 is provided. The substrate 21 can be provided on the surface opposite to the bottom surface 11a1 in the seat portion 215 with the heat transfer portion 40 interposed therebetween.

As illustrated in FIG. 4A, the planar dimension of the seat portion 215 is set to be smaller than the planar dimension of the substrate 21. The seat portion 215 can be similar to the seat portion 15a. For that reason, when the seat portion 215 is provided, it is possible to suppress an adhesive, grease or the like from rising on a surface provided with the light-emitting element 22 and the like in the substrate 21.

Incidentally, since thermal resistance increases when the planar dimension of the seat portion 215 is small, heat generated in the light-emitting module 20 is not easily radiated.

Here, the convex portion 15 according to the embodiment is provided with the connection portion 15b.

As illustrated in FIGS. 3A and 3B, the connection portion 15b can protrude from the bottom surface 11a1 of the concave portion 11a. A distance between the bottom surface 11a1 and a surface opposite to the bottom surface 11a1 in the connection portion 15b can be equal to or smaller than a distance between the bottom surface 11a1 and a surface opposite to the bottom surface 11a1 in the seat portion 15a. In a direction orthogonal to a direction from one end portion of the connection portion 15b to the other end portion of the connection portion 15b, the planar dimension (the width W) of the connection portion 15b can be set to be smaller than the planar dimension of the seat portion 15a.

In plan view, the connection portion 15b can be provided between the seat portion 15a and the side wall of the concave portion 11a. One end portion of the connection portion 15b can be connected to the side wall of the seat portion 15a and the other end portion thereof can be connected to the side wall of the concave portion 11a.

Heat generated in the light-emitting module 20 can be mainly transferred to the thermal radiation fin 14 through the seat portion 15a. The heat transferred to the thermal radiation fin 14 can be discharged from the thermal radiation fin 14 to the outside. When the connection portion 15b is provided, a part of the heat transferred to the seat portion 15a can be transferred to the attachment portion 11. A part of the heat transferred to the attachment portion 11 can be transferred to the flange 13. Since the attachment portion 11 and the flange 13 contact the casing 101 of the vehicle lamp 100, the heat transferred to the attachment portion 11 and the flange 13 can be discharged to the outside through the casing 101.

That is, when the connection portion 15b is provided, heat generated in the light-emitting module 20 can be also diffused in a direction orthogonal to the center axis 1a of the vehicle luminaire 1. For that reason, it is possible to efficiently transmit heat generated in the light-emitting module 20 to the socket 10 and to suppress the rise of the adhesive, grease or the like.

At least one connection portion 15b can be provided. In this case, the amount of heat transferred to the attachment portion 11 can be increased when the number of the connection portions 15b is increased. However, when the number of the connection portions 15b is too large, the remaining adhesive, grease or the like is not easily received in the space.

The number or arrangement of the connection portions 15b can be appropriately determined in response to the viscosity of the adhesive, grease or the like, the heat generation position of the light-emitting module 20, and the like. For example, the number or arrangement of the connection portions 15b can be determined by an experiment or simulation.

Here, when the height H of the seat portion 15a (a distance between the bottom surface 11a1 and a surface opposite to the bottom surface 11a1 in the seat portion 15a) is too small, there is concern that an adhesive, grease or the like may rise on the surface of the substrate 21. Meanwhile, when the height H of the seat portion 15a is too large, there is concern that the heat transferred to the thermal radiation fin 14 is little.

According to the knowledge of the inventors, the height H of the seat portion 15a is desirably 0.5 mm or more and 1 mm or less. With such dimensions, it is easy to transfer heat and to suppress the rise of the adhesive, grease or the like.

Further, when the distance L between the peripheral edge of the substrate 21 and the peripheral edge of the seat portion 15a is too small, there is concern that the adhesive, grease or the like rises on the surface of the substrate 21. Meanwhile, when the distance L is too long, there is concern that the heat transferred to the thermal radiation fin 14 is little.

According to the knowledge of the inventors, the distance L is desirably 0.5 mm or more and 1 mm or less. With such dimensions, it is easy to transfer heat and to suppress the rise of the adhesive, grease or the like.

The height of the connection portion 15b (a distance between the bottom surface 11a1 and a surface opposite to the bottom surface 11a1 in the connection portion 15b) can be equal to or smaller than the height H of the seat portion 15a.

When the width W of the connection portion 15b (a dimension in a direction orthogonal to a direction from one end portion to the other end portion of the connection portion 15b) is too large, there is concern that an adhesive, grease or the like may rise on the surface of the substrate 21. Meanwhile, when the width W of the connection portion 15b is too small, there is concern that the heat transferred to the attachment portion 11 is little.

According to the knowledge of the inventors, the width W of the connection portion 15b is desirably 0.2 mm or more and 5.0 mm or less. With such dimensions, it is easy to transfer heat and to suppress the rise of the adhesive, grease or the like.

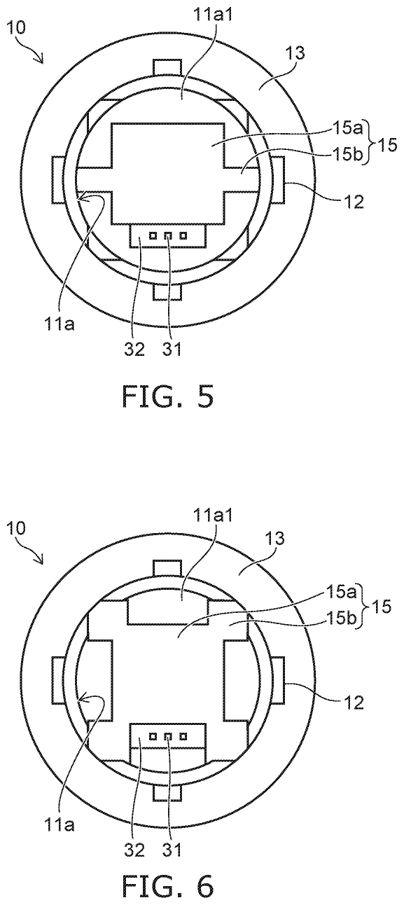

FIGS. 5 and 6 are schematic front views illustrating the number and arrangement of the connection portions 15b.

As described above, the number or arrangement of the connection portions 15b can be appropriately determined in response to the viscosity of the adhesive, grease or the like, the heat generation position of the light-emitting module 20, and the like.

For example, two connection portions 15b illustrated in FIG. 3A are connected to one side wall of the seat portion 15a.

For example, one connection portion 15b illustrated in FIG. 5 is connected to each of two side walls of the seat portion 15a.

For example, one connection portion 15b illustrated in FIG. 6 is connected to each of four corner portions of the seat portion 15a.

As described above, a case in which the planar shape of the seat portion 15a is a square has been exemplified, but the planar shape of the seat portion 15a can be a desired shape such as a polygon, a circle, and an ellipse. However, the planar shape of the seat portion 15a is desirably similar to the planar shape of the substrate 21. For example, when the planar shape of the substrate 21 is a square, the planar shape of the seat portion 15a is desirably a square. In this way, the distance L between the peripheral edge of the substrate 21 and the peripheral edge of the seat portion 15a can be constant.

For that reason, it is easy to suppress an adhesive, grease or the like from rising on the entire peripheral edge of the substrate 21.

(Vehicle Lamp)

Next, the vehicle lamp 100 will be illustrated.

Additionally, hereinafter, a case in which the vehicle lamp 100 is a front combination light provided in an automobile will be described as an example. However, the vehicle lamp 100 is not limited to the front combination light provided in the automobile. The vehicle lamp 100 may be a vehicle lamp provided in an automobile, a railway car or the like.

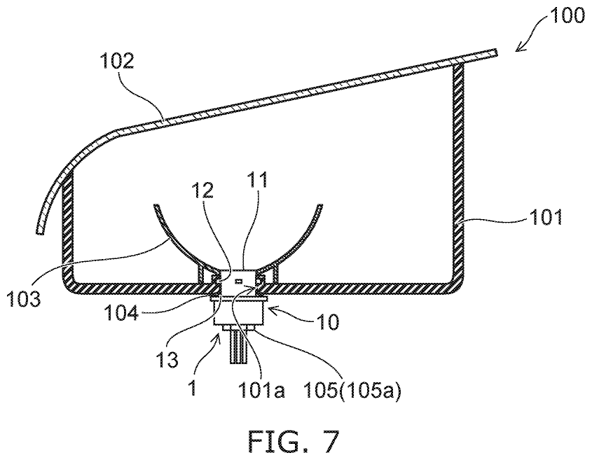

FIG. 7 is a partially cross-sectional view schematically illustrating the vehicle lamp 100.

As illustrated in FIG. 7, the vehicle lamp 100 can be provided with the vehicle luminaire 1, the casing 101, a cover 102, an optical element 103, a seal member 104, and the connector 105.

The vehicle luminaire 1 can be attached to the casing 101. The casing 101 can hold the attachment portion 11. The casing 101 can have a box shape of which one end portion side is opened. The casing 101 can be formed of, for example, a resin that does not transmit light. The bottom surface of the casing 101 can be provided with the attachment hole 101a into which a portion provided with the bayonet 12 is inserted in the attachment portion 11. The peripheral edge of the attachment hole 101a can be provided with a concave portion into which the bayonet 12 provided on the attachment portion 11 is inserted. Additionally, a case in which the attachment hole 101a is directly provided in the casing 101 is illustrated, but an attachment member with the attachment hole 101a may be provided in the casing 101.

At the time of attaching the vehicle luminaire 1 to the vehicle lamp 100, a portion provided with the bayonet 12 on the attachment portion 11 is inserted into the attachment hole 101a and the vehicle luminaire 1 is rotated. Then, for example, the bayonet 12 is held by a fitting portion provided in the peripheral edge of the attachment hole 101a. Such an attachment method is called a twist lock.

The cover 102 can be provided so as to block the opening of the casing 101. The cover 102 can be formed of a resin having translucency. The cover 102 can have a function of a lens or the like.

Light emitted from the vehicle luminaire 1 is incident on the optical element 103. The optical element 103 can perform at least one of a reflecting operation, a diffusing operation, a guiding operation, a collecting operation, and a predetermined light distribution pattern forming operation of the light emitted from the vehicle luminaire 1. For example, the optical element 103 illustrated in FIG. 7 is a reflector. In this case, the optical element 103 can form a predetermined light distribution pattern by reflecting light emitted from the vehicle luminaire 1.

The seal member 104 can be provided between the flange 13 and the casing 101. The seal member 104 can have an annular shape. The seal member 104 can be formed of an elastic material such as rubber or silicone resin.

When the vehicle luminaire 1 is attached to the vehicle lamp 100, the seal member 104 is sandwiched between the flange 13 and the casing 101. For that reason, the internal space of the casing 101 can be sealed by the seal member 104. Further, the bayonet 12 is pressed against the casing 101 by the elastic force of the seal member 104. For that reason, it is possible to suppress the vehicle luminaire 1 from being separated from the casing 101.

The connector 105 can be fitted to the end portions of the plurality of power-supply terminals 31 exposed into the hole 10b. A power supply (not illustrated) or the like can be electrically connected to the connector 105. For that reason, a power supply (not illustrated) can be electrically connected to the light-emitting element 22 by fitting the connector 105 to the end portions of the plurality of power-supply terminals 31.

Further, the connector 105 can be provided with the seal member 105a. When the connector 105 with the seal member 105a is inserted into the hole 10b, the hole 10b is sealed so as to be watertight. The seal member 105a can be formed of an elastic material such as rubber or silicone resin into an annular shape.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A vehicle luminaire comprising:
a socket which includes a concave portion opening to one end portion and a convex portion provided in a bottom surface of the concave portion; and
a light-emitting module which is provided inside the concave portion,
the convex portion including: a seat portion which protrudes from the bottom surface of the concave portion; and at least one connection portion of which one end portion is connected to a side wall of the seat portion and the other end portion is connected to a side wall of the concave portion,
the light-emitting module including: a substrate which is provided in a surface opposite to the bottom surface of the concave portion in the seat portion with a heat transfer portion interposed therebetween; and at least one light-emitting element which is provided in the substrate,
a planar dimension of the seat portion being smaller than a planar dimension of the substrate.

2. The luminaire according to claim 1, wherein
a planar dimension of the connection portion is smaller than a planar dimension of the seat portion in a direction orthogonal to a direction from one end portion of the connection portion to the other end portion of the connection portion.

3. The luminaire according to claim 1, wherein
a part of the heat transfer portion is provided in at least a part of a side wall of the seat portion.

4. The luminaire according to claim 1, wherein
a surface opposite to the bottom surface of the concave portion in the seat portion is a flat surface.

5. The luminaire according to claim 1, wherein
the vicinity of a peripheral edge of the substrate is located on the outside in relation to a peripheral edge of the seat portion in plan view.

6. The luminaire according to claim 1, wherein
a space is provided between the vicinity of a peripheral edge of the substrate and the bottom surface of the concave portion.

7. The luminaire according to claim 1, wherein
the connection portion is connected to the bottom surface of the concave portion.

8. The luminaire according to claim 1, wherein
a distance between the bottom surface of the concave portion and a surface opposite to the bottom surface in the connection portion is equal to a distance between the bottom surface and a surface opposite to the bottom surface in the seat portion.

9. The luminaire according to claim 1, wherein
a distance between the bottom surface of the concave portion and a surface opposite to the bottom surface in the connection portion is smaller than a distance between the bottom surface and a surface opposite to the bottom surface in the seat portion.

10. The luminaire according to claim 1, wherein
a height of the seat portion is 0.5 mm or more and 1 mm or less.

11. The luminaire according to claim 1, wherein
a distance between a peripheral edge of the substrate and a peripheral edge of the seat portion is 0.5 mm or more and 1 mm or less.

12. The luminaire according to claim 1, wherein
a planar dimension of the connection portion is 0.2 mm or more and 5.0 mm or less in a direction orthogonal to a direction from one end portion of the connection portion to the other end portion of the connection portion.

13. The luminaire according to claim 1, wherein
a planar shape of the seat portion is a square, and
two connection portions are connected to any one of four side walls of the seat portion.

14. The luminaire according to claim 1, wherein
a planar shape of the seat portion is a square, and
one connection portion is connected to each of any two of four side walls of the seat portion.

15. The luminaire according to claim 1, wherein
a planar shape of the seat portion is any one of a polygon, a circle, and an ellipse.

16. The luminaire according to claim 1, wherein
a planar shape of the seat portion is similar to a planar shape of the substrate.

17. The luminaire according to claim 1, wherein
the heat transfer portion includes a filler using an inorganic material.

18. The luminaire according to claim 1, wherein
the seat portion includes a high thermal conductive resin.

19. The luminaire according to claim 1, wherein
the connection portion is integrally formed with the seat portion by including a high thermal conductive resin.

20. A vehicle lamp comprising:
the vehicle luminaire according to claim 1; and
a casing to which the vehicle luminaire is attached.
